(19) United States
(12) Patent Application Publication
(10) Pub. No.: US 2017/0108283 A1
(43) Pub. Date: Apr. 20, 2017

(54) HEAT EXCHANGER FOR A MOTOR VEHICLE

(71) Applicant: Valeo Systemes Thermiques, Le Mesnil Saint Denis (FR)

(72) Inventors: Sébastien DEVEDEUX, Versailles (FR); Laurent ODILLARD, Le Luart (FR); Benjamin FERLAY, Cernay La Ville (FR)

(73) Assignee: VALEO SYSTEMES THERMIQUES, Le Mesnil Saint Denis (FR)

(21) Appl. No.: 15/301,616

(22) PCT Filed: Apr. 3, 2015
(86) PCT No.: PCT/EP2015/000722

§ 371 Date: Oct. 3, 2016

(30) Foreign Application Priority Data
Apr. 4, 2014 (FR) 1453010

(51) Int. Cl. F28D 9/00; F28F 9/00; F02M 35/10; F28F 9/02

(52) U.S. Cl. CPC F28D 9/0056; F28F 9/0219; F28F 9/001; F02M 35/10268; F28D 2021/0082

(57) ABSTRACT

The invention relates to a heat exchanger (1) for exchanging heat between a first and a second fluid, in particular for supplying the combustion engine of a motor vehicle with air, the heat exchanger comprising at least one heat-exchanging nest (5) through which flows the first fluid F1 and a casing (7) in which the heat-exchanging nest (5) is accommodated such that the second fluid F2 can flow therethrough. The heat-exchanging nest (5) comprises plates (23) for the circulation of the first fluid F1, the plates being stacked one on top of the other, at least one of the plates (23) having a rim (29) disposed between the heat-exchanging nest (5) and the casing (7) so as to restrict the second fluid F2 in its flow about the nest.

The invention relates to a heat exchanger, notably for supplying air to motor vehicle engines, and more particularly to engines the charge air of which comes from a compressor or turbocompressor delivering what is referred to as supercharging air.

In what follows, charge air or supercharging air is to be understood as covering both air coming from the air intake circuit of the engine alone and as covering a mixture of air and exhaust gas recovered at the outlet of the engine, according to the system generally known by the acronym EGR (exhaust gas recirculation).

In order to increase the density of the charge air admitted to a turbocharged engine, it is known practice to cool the charge air leaving the compressor by means of a heat exchanger which is also known as a charge air cooler or CAC for short.

A charge air cooler comprises at least one heat exchange core bundle. Heat exchange core bundles comprising a stack of plates alternately forming circulation ducts for the charge air that is to be cooled and ducts for the circulation of the exchange cooling fluid, are particularly known.

This exchanger is generally incorporated into the intake manifold of the combustion engine. The effectiveness of the exchange of heat is greatly dependent on the level of leaks between the core bundle and the manifold. A poor configuration in this region leads to a significant drop in exchanger performance. In addition, it is of key importance to guarantee accurate and repeatable positioning of the core bundle within the manifold in order to encourage correct operation.

To this end, the invention relates to a heat exchanger for the exchange of heat between a first and a second fluid, notably for supplying air to a motor vehicle combustion engine, comprising at least one heat exchange core bundle through which the first fluid passes and a casing in which said heat exchange core bundle is housed so that the second fluid can pass through it, the heat exchange core bundle comprising plates for the circulation of the first fluid which are stacked on one another.

According to the invention, at least one of said plates has a rim placed between said heat exchange core bundle and said casing so as to limit the extent to which the second fluid can bypass the core bundle.

A “rim” here means any part of the contour of the plate that is placed transversely in the stream of second fluid, particularly any part of the contour of the plate the function of which is not to assemble the plate with the rest of the bundle. In other words, the clearance provided between the core bundle and the casing is blocked off by the plates of the bundle themselves, via the rims thereof. As a result, direct passage of the second fluid from an inlet to an outlet of the casing without passing through the heat exchange core bundle is prevented. This then prevents a fraction of the second fluid from being able to leave the exchanger without having been cooled.

Advantageously, the casing is configured to be connected to air intakes of an engine. Said heat exchanger is notably used to cool the engine charge air.

According to other features of the invention which may be considered alone or in combination:
the rim or rims are perpendicular to a plane of extension of their respective plate,
said core bundle has lateral faces and the rims extend between at least one of said lateral faces and said casing,
at least at one of said lateral faces, or even at each of the lateral faces of the core bundle, the rims are arranged in succession along one and the same direction parallel to a direction of stacking of said plates,
said successive rims situated along one and the same lateral face form an overall lateral rim,
said casing is closed along one of its faces by a plate referred to as the frontal flange, to which said heat exchange core bundle is fixed, notably in a fluidtight fashion,
said heat exchange core bundle comprises, on a face opposite to said frontal flange, a plate referred to as a structural plate,
said structural plate comprises at least one edge passing through a plane containing said rim or rims of the plates,
said edge and said rim or rims form a U-shaped outline of the core bundle,
said rim or rims are situated at the level of an outlet face of the core bundle,
said rims project from a top of the plates,
said rims are arranged along an edge of a longitudinal inlet or outlet face via which the second fluid enters or leaves the core bundle, particularly along an edge of the longitudinal outlet face via which the second fluid leaves the core bundle,
said heat exchange core bundle is a rectangular parallelepiped,
said core bundle has a large face secured to said frontal flange, an opposite large face, said lateral faces connecting said large faces, said heat exchange core bundle being closed on the large face opposite to said frontal flange by said structural plate,
said rim or rims are perpendicular to the lateral faces of the core bundle,
said rim or rims and/or said edge are produced as one with the core bundle plates and/or the structural plate,
said rim or rims and/or said edge are attached on to the core bundle plates and/or the structural plate,
said rim or rims are able to engage against a wall of the casing and/or a complementary part of the casing, particularly by way of a cross section and/or a fold, notably a regular one, of said rim or rims,
said rim or rims and/or said edge bears a seal able to engage against the wall of the casing and/or said complementary part of the casing,
said rim or rims and/or said edge comprise a contact part, notably a profiled external contact part, that can be applied, notably compressed, against the wall of the casing or said complementary part of the casing, so as to provide sealing between the core bundle and the casing against the second fluid,
said contact part comprises a coating of contact material, such as adhesive, resin, thermoplastic or elastomer, such as said seal
said coating is able to be bonded and/or fixed, notably clipped, to said rim or rims and/or said edge,
said coating or seal is shaped as a U so as to extend along said lateral faces of the core bundle and the structural plate,
said coating or seal is provided with two hinge zones, one at each of the ends of the main branch of the U corresponding to the structural plate, said hinge zones being able to make the U open wider and bring it into an initial profile so as to allow the coating or seal to be mounted on the rim easily,
said casing comprises a housing for said rim or rims, said housing being configured in a rib profile,
said housing is configured in a rib profile that notably allows the core bundle equipped with said rim or rims to be mounted in the casing by sliding,
said housing is configured to be rigid so as to allow the core bundle to be mechanically held firmly in the casing, notably acting as a stiffener, thereby limiting clearances and the amount of unsupported overhang in the connection between the core bundle and the casing and containing vibrations so that the vibrational frequency modes of the core bundle are increased and the amplitudes of the vibrations in each mode are attenuated,
said seal is compressed in said housing,
the seal comprises a support bead collaborating with said housing, notably to hold the core bundle in the casing.

The invention also relates to a vehicle engine intake module comprising a heat exchanger as described hereinabove.

Further advantages and features of the invention will become further apparent with reference to the description of some embodiments of the invention and with reference to the attached drawings, in which:

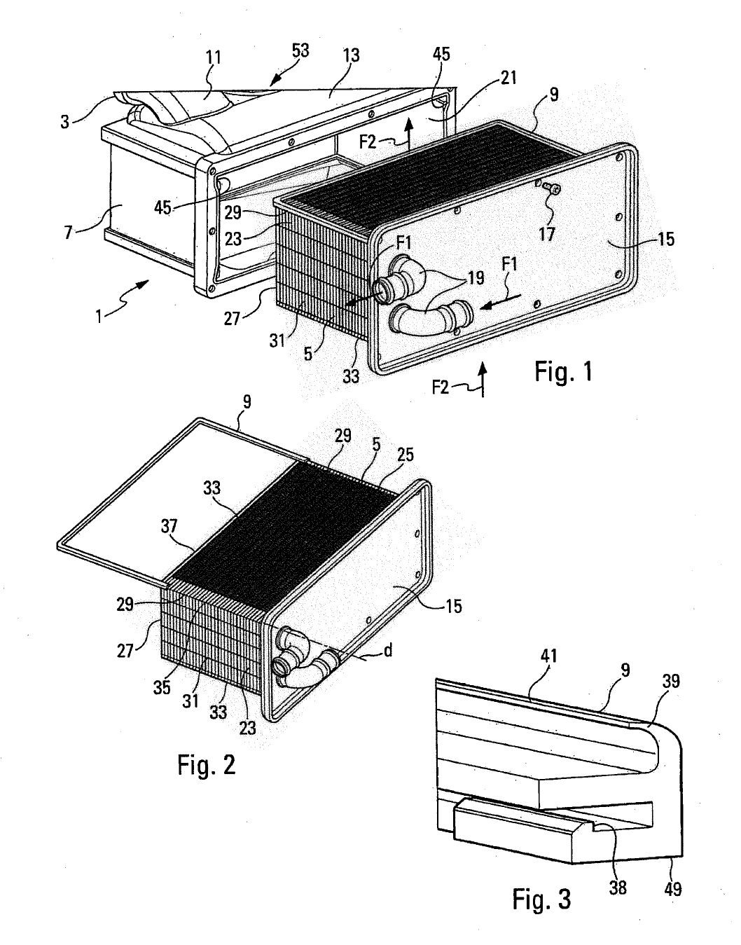

FIG. 1 is an exploded perspective schematic view of a heat exchanger according to one embodiment of the invention, said rim or rims of the exchanger being fitted with a seal,

FIG. 2 is a perspective schematic view of the heat exchange core bundle and of the seal, in the process of assembly, of the heat exchanger according to FIG. 1,

FIG. 3 is an enlarged perspective view of the seal, in particular showing the cross section thereof,

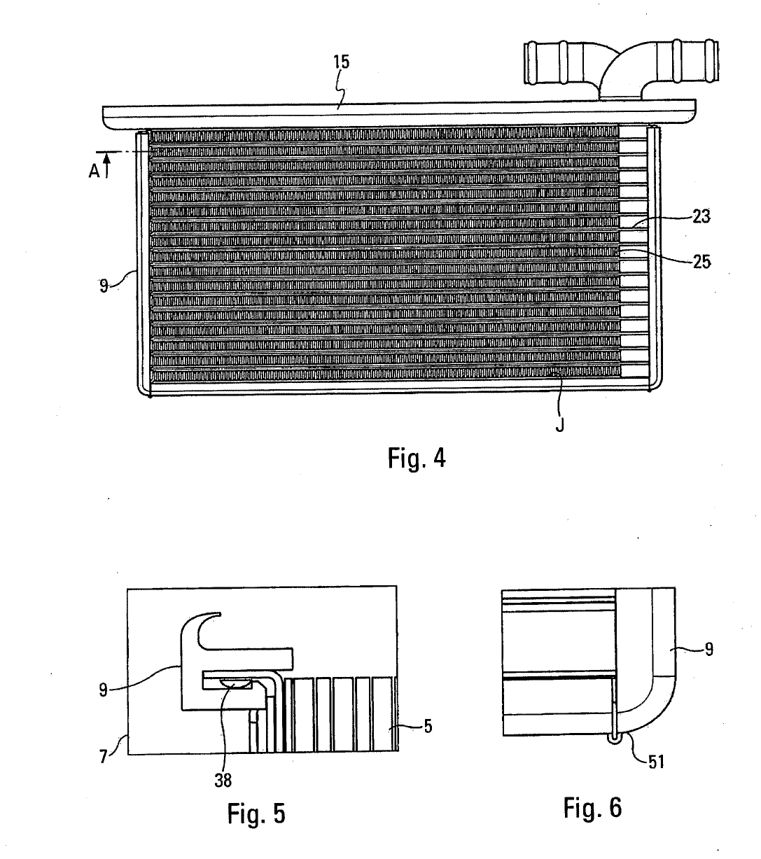

FIG. 4 is an elevation view of the heat exchange core bundle of the exchanger of FIG. 1,

FIG. 5 is a view in part section on A-A of FIG. 4,

FIG. 6 is an enlarged view of a detail of FIG. 4 in the region of a hinge zone of the seal,

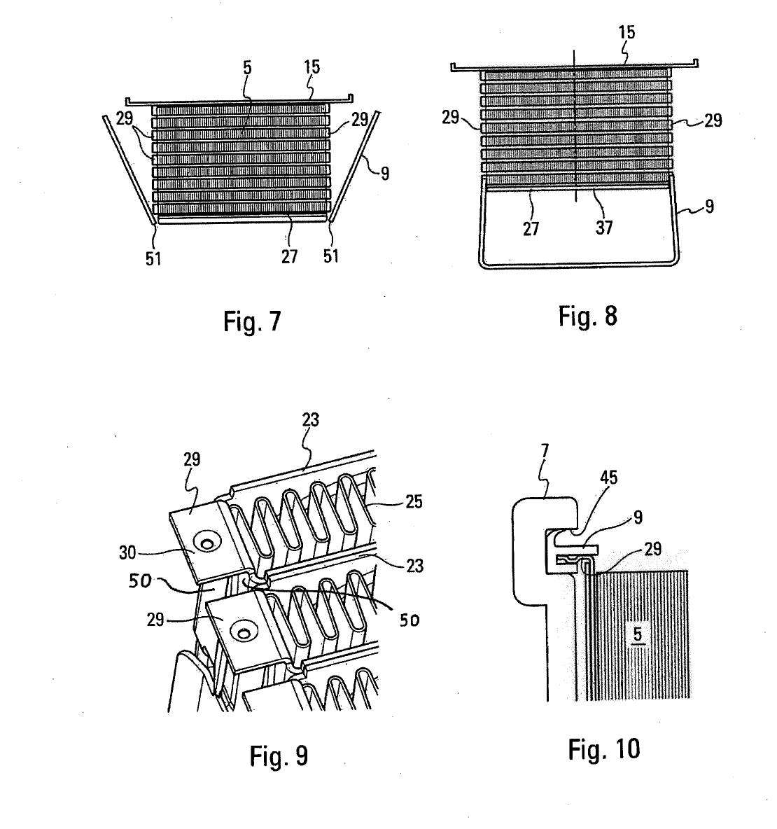

FIGS. 7 and 8 are views of the heat exchange core bundle showing ways of mounting the seal,

FIG. 9 is a perspective view of the rims of plates of the core bundle of FIG. 4,

FIG. 10 is a part section similar to FIG. 5 of the plate rim and the seal thereof,

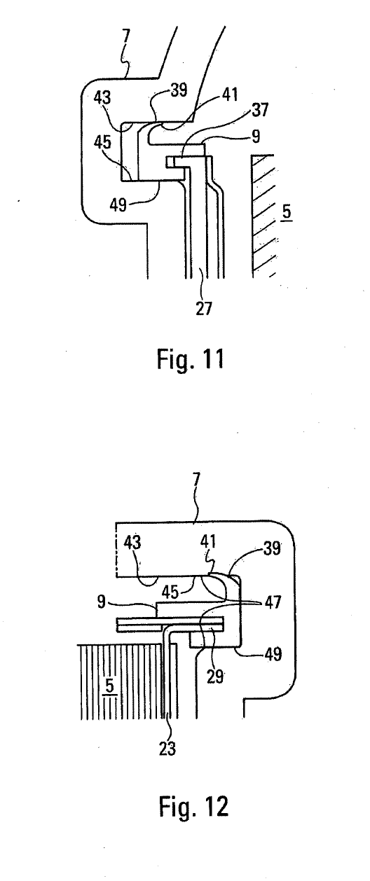

FIG. 11 is a view in part section of the rim of a structural plate of the core bundle and of the seal thereof,

FIG. 12 is a view in part section similar to FIG. 5 showing an alternative form of embodiment of the plate rim and of its seal.

With reference to the drawings, particularly to FIGS. 1 and 2, the invention relates to a heat exchanger 1, notably for supplying charge air to a motor vehicle combustion engine, as here. The exchanger allows an exchange of heat between a first fluid F1 and a second fluid F2. In the application illustrated, the first fluid F1 is a liquid coolant, notably glycol water, and the second fluid F2 is the charge air that needs to be cooled. This exchanger 1 thus, for example, forms a charge air cooler incorporated into an intake manifold 3 of the combustion engine.

Said exchanger 1 comprises at least one heat exchange core bundle 5 through which the first fluid F1 passes and a casing 7 in which said heat exchange core bundle is housed so that said second fluid F2 can pass through it.

The heat exchange core bundle comprises plates 23 for the circulation of the first fluid F1 which are stacked on one another.

According to the invention, said plates 23 have one or more rims 29, as depicted in FIGS. 9 and 10, arranged between said heat exchange core bundle 5 and said casing 7 so as limit the extent to which the second fluid F2 can bypass the core bundle.

By virtue of the invention, a passage of the second fluid F2 between the heat exchange core bundle 5 and the casing 7 is limited, or even prevented, notably by creating a pressure drop across the passage. Such a feature makes it possible to greatly improve the thermal efficiency of the exchanger. Specifically, because of the high density of the core bundle and therefore of the appreciable pressure drop imposed on the second fluid F2 in the bundle, even a minimal amount of leakage between the casing and the core bundle would lead to a significant throughput of uncooled gas through the exchanger.

As can be seen in FIG. 1, the casing 7 is configured here to be connected to the air intakes 11 of the engine. It notably comprises a proeminence or outlet manifold 13 on one of its large faces, by means of which feature it is connected to said intakes 11. An inlet manifold for the second fluid is situated on the opposite face.

Said casing 7 here is closed on one of its faces by a plate referred to as a frontal flange 15, to which said heat exchange core bundle 5 is fixed in a fluidtight fashion, notably by brazing. This frontal flange 15 is fixed, for example by screws 17, to the casing 7. A seal, not depicted, may be used between said flange 15 and said casing 7 in order to prevent leaks of second fluid to the outside. Said flange 15 also comprises inlet and outlet pipes 19 by which the first fluid F1 enters and leaves the heat exchange core bundle. It should be noted that this frontal flange 15 closes an opening 21 of the casing which is intended for the passage of the heat exchange core bundle 5 when the latter is being mounted inside the casing.

Said heat exchange core bundle 5 in this instance is a rectangular parallelepiped. It comprises a stack of plates 23 alternately forming circulation ducts for the first and for the second fluids. The plates are, for example, assembled in pairs to form circulation ducts for the first fluid. In this instance, said ducts are configured in a U shape and the first fluid enters and leaves plate pairs at orifices situated along one and the same side 31 of the core bundle 5. The orifices of the plate pairs communicate with one another from pair to pair to form an inlet manifold and an outlet manifold for the first fluid, these respectively communicating with the pipes 19 of the frontal flange 15. Said plates are formed, for example, by pressing and are then stacked and brazed together.

The rims 29 in this instance originate from the plates and are formed by bending, with a single thickness as illustrated in FIGS. 9 and 10 or a double thickness, FIG. 12, according to an alternative form of embodiment. In succession they form an overall rim 30, which is notably rectilinear. These rims could alternatively be fixed to the plates as an added on component, for example using brazing.

As is more particularly visible in FIG. 9, said plates 23 have, for example, lateral edges 50, situated at the lateral faces of the bundle. Said lateral edges 50 emanate from the plane of said plates 23, notably by bending. In this instance, said lateral edges 50 of the plates 23 partially overlap from one plate pair to another.

Said rims 29 are derived, advantageously by bending, from said lateral edges 50, particularly from the lateral edges 50 situated toward the inside. In other words, the rim 29 of one of the plates 23 overlaps the lateral edge 50 overlapping the lateral edge 50 from which said rim 29 is itself derived.

The exchange of heat between the plates 23 and the second fluid may be achieved, in part, through the agency of turbulators 25 situated between the plate pairs.

Said heat exchange bundle 5 here is closed along a large face, on the opposite side to said frontal flange 15, by a plate referred to as a structural plate 27.

This plate 27 is, for example, fixed to the core bundle by brazing. As an alternative, it may be one of the plates of the bundle.

The plates 23 may each have a rim 29 formed projecting from their plane, notably perpendicular to their plane. The rim 29 here is perpendicular to the lateral faces 31 of the core bundle, namely the faces adjacent to the longitudinal inlet and outlet faces 33 via which the air enters and leaves the core bundle. This or these rims 29, particularly visible in FIGS. 7 to 10, are preferably arranged as a plurality of identical rims 29, uniformly spaced apart at the plate pairs.

Said rim or rims 29 are advantageously arranged in one and the same direction parallel to the direction of stacking of the plates. They are situated, for example, along an edge 35 of a longitudinal face 33 of the bundle, in this instance the longitudinal face for the outlet of the second fluid.

In other words, said rims 29, as mentioned, form an overall rim along a line d which in this instance is an edge line 35 of said longitudinal face 33 for the outlet of the second fluid from the core bundle.

Said rims 29 could be extended along said longitudinal face 33 so as to come into contact with the turbulators 25. They then form a screen preventing the second fluid from passing in zones of the plates that are not covered with said turbulators, thereby encouraging the exchange of heat.

Said structural plate 27 also comprises at least one edge 37, in this instance a uniform edge 37, FIG. 11, passing through a plane containing said rim or rims 29 of the plates 23. This edge 37 is rectilinear, perpendicular to the plane of the structural plate 27.

Although said rims 29 and/or said edge 37 are able by themselves to limit the passage of the second fluid between the casing and the core bundle, a seal or sealing coating 9 is advantageously mounted along said rim or rims 29 of the plate of the core bundle and/or along said edge 37 of the structural plate, being fixed, for example clipped or bonded, thereto.

Advantageously, said seal 9 is mounted on said rims 29 of the plate of the core bundle and on said edge 37 of the structural plate, along three sides of the core bundle 5, as here. It is notably configured to have a U-shaped profile, FIGS. 7 and 8, so as to extend longitudinally and in continuity along said rims 29 of the plate of the bundle and said rim 37 of the structural plate, along each of said lateral faces 31 and structural plate 27 of the bundle, until it comes into contact with said flange 15.

In addition, said seal 9 has a uniform U-shaped cross section, FIG. 3, able to allow the seal to engage on or accept said rims 29 of the plate of the core bundle and said edge 37 of the structural plate. The engagement may be a relatively close fit so as to provide the seal with retention after engagement. The profiles of the rims 29 and 37 are identical here but could be different, the seal 9 having a complementing profile.

For preference, said seal 9 is able to be fixed, notably clipped by a hook 38 of the U, as can be seen in FIG. 5, to said rim 29 of the plate of the core bundle and said rim 37 of the structural plate, after it has been engaged on these.

Said seal 9 comprises, FIGS. 11 and 12, a profiled external lip 39, in this instance having a longitudinal profile of rounded cross section tapering at the end 41.

Said external lip 39 is able to be pressed, notably compressed, against a wall 43 of the casing, so as to confer sealing between the core bundle and the casing against the second fluid.

More specifically, the seal 9 is housed in a profiled recess 45 of the casing, that complements the seal. The recess 45 in this instance has a rectangular cross section that accommodates the seal 9, notably so that it is compressed between two opposing lateral faces 47 of the recess. The seal 9 notably comprises a beadlike part 49 at the opposite end to the lip 39, thereby allowing the core bundle 5 to be held firmly in the casing 7.

Said seal 9 is advantageously an element made of thermoplastic or elastomer, notably deformable within a certain tolerance band in order to withstand said sealing compression. This tolerance before and after compression is, for example, comprised between 0.1 mm and 0.25 mm.

As mentioned previously, said seal 9 is U-shaped so as to extend along said lateral faces 31 and the structural plate 27 of the core bundle. At each of the ends of the main branch of the U, corresponding to the structural plate 27, the seal 9 here is provided with a hinge zone 51, see FIGS. 6 and 7, said two hinge zones 51 being designed to increase the openness of the

U when the seal is being mounted on the core bundle and to return the U to its initial configuration upon engagement over said rims 29, 37. Such an arrangement makes the seal easier to mount on the core bundle. The seal may even be slid along the rims 29, FIG. 8, until it is engaged over the rim 37 at the end of the fitting of the seal.

Said casing 7 advantageously comprises a housing for said seal 9, which in this instance is said recess 45.

This housing 45 is shaped into a rib profile, particularly in said rectangular section, so as to allow the core bundle 5 equipped with the seal 9 to be mounted in the casing 7 by sliding from the opening 21.

Said housing 45 may be configured to be rigid so as to allow the core bundle 5 to be mechanically held firmly in the casing 7, notably by acting as a stiffener. This arrangement makes it possible to eliminate clearances and unsupported overhang in the connection between the core bundle and the casing and damps out vibrations. Thus, the vibrational frequency modes of the core bundle and, thereby, of the exchanger 1, are increased and the amplitudes of the vibrations in each mode are attenuated. The reliability of the exchanger and the quiet operation thereof are improved.

The way of assembling such a heat exchanger 1 is now described. The method involves the following steps:
mounting said seal 9 on the heat exchange core bundle 5, notably on said rim or rims 29 of the core bundle plate and on the edge 37 of the structural plate, and
mounting the core bundle 5 equipped with the seal in the casing 7, particularly by sliding into the casing 7 from the opening 21 thereof along said recess 45.

Said core bundle 5 is then fixed to the casing 7 by means of the frontal flange 15 which in this instance is screwed on to an edge of an opening 21 of the casing.

In alternative forms that have not been illustrated, the coating provided on the rims of the plates and/or on said edge of the structural plate of the core bundle to come into contact with the casing may be a material of the glue, resin and/or thermoplastic material type. Said rims and/or said edge could also come into contact with said casing without the interposition of a coating.

The invention also relates to a vehicle engine intake module (53) comprising a heat exchanger as described hereinabove and visible in part in FIG. 1.

The invention thus provides a heat exchanger, notably a charge air cooler, for a vehicle engine, which performs well, quietly and reliably.

1. A heat exchanger (1) for the exchange of heat between a first and a second fluid, notably for supplying air to a motor vehicle combustion engine, comprising at least one heat exchange core bundle (5) through which the first fluid F1 passes and a casing (7) in which said heat exchange core bundle (5) is housed so that the second fluid F2 can pass through it, the heat exchange core bundle (5) comprising plates (23) for the circulation of the first fluid F1 which are stacked on one another, at least one of said plates (23) having a rim (29) placed between said heat exchange core bundle (5) and said casing (7) so as to limit the extent to which the second fluid F2 can bypass the core bundle.

2. The heat exchanger as claimed in claim 1, in which the rim or rims are perpendicular to a plane of extension of their respective plate.

3. The heat exchanger as claimed in claim 1, in which said core bundle has lateral faces and the rims extend between at least one of said lateral faces and said casing.

4. The heat exchanger as claimed in the preceding claim 3, in which, at least at one of said lateral faces, the rims are arranged in succession along one and the same direction parallel to a direction of stacking of said plates.

5. The heat exchanger as claimed in claim 1, in which said successive rims situated along one and the same lateral face form an overall lateral rim.

6. The heat exchanger as claimed in claim 1, in which said casing is closed along one of its faces by a plate referred to as the frontal flange, to which said heat exchange core bundle is fixed and in which said heat exchange core bundle comprises, on a face opposite to said frontal flange, a plate referred to as a structural plate.

7. The heat exchanger as claimed in claim 6, in which said structural plate comprises at least one edge passing through a plane containing said rim or rims of the plates.

8. The heat exchanger as claimed in claim 7, in which said edge and said rim or rims form a U-shaped outline of the core bundle.

9. The heat exchanger as claimed in claim 7, in which said rim or rims and/or said edge bears a seal able to engage against a wall of the casing and/or a complementary part of the casing.

10. The heat exchanger as claimed in claim 1, in which said rim or rims are situated at the level of an outlet face of the core bundle.

11. The heat exchanger as claimed in claim 1, in which said rims project from a top of the plates.

12. The heat exchanger as claimed in claim 11, in which said rims are arranged along an edge of a longitudinal inlet or outlet face via which the second fluid enters or leaves the core bundle, along an edge of the longitudinal outlet face via which the second fluid leaves the core bundle.

13. The heat exchanger as claimed in claim 1, in which said casing comprises a housing for said rim or rims, said housing being configured in a rib profile.

14. The heat exchanger as claimed in claim 13, in which said housing is configured to be rigid so as to allow the core bundle to be mechanically held firmly in the casing.

15. A motor vehicle air intake module comprising a heat exchanger as claimed in claim 1.
